(19) United States
(12) Patent Application Publication
(10) Pub. No.: US 2015/0274191 A1
(43) Pub. Date: Oct. 1, 2015

(54) RACK FOR A RACK-AND-PINION STEERING SYSTEM OF A MOTOR VEHICLE

(71) Applicant: SCHAEFFLER TECHNOLOGIES AG & CO. KG, Herzogenaurach (DE)

(72) Inventor: Tobias Vogler, Herzogenaurach (DE)

(73) Assignee: Schaeffler Technologies AG & Co. KG, Herzogenaurach (DE)

(21) Appl. No.: 14/438,710

(22) PCT Filed: Oct. 23, 2013
(86) PCT No.: PCT/DE2013/200242

§ 371 Date: Apr. 27, 2015

(30) Foreign Application Priority Data
Oct. 31, 2012 (DE) 10 2012 219 888.1

(51) Int. Cl. B62D 3/12; F16H 25/20; B62D 7/09; F16H 55/26

(52) U.S. Cl. CPC B62D 3/126; F16H 55/26; F16H 25/20; B62D 7/09

(57) ABSTRACT

A rack (7, 31) for a rack-and-pinion steering system of a motor vehicle, having a variable toothing (12, 13) formed from a plurality of teeth (14, 15) arranged along a rack axis for the engagement of a pinion (18, 17, 43, 44), wherein the rack (7, 31) is formed by two rack parts (8, 9, 32, 33) that are arranged movably with respect to one another and which both have an identical variable toothing (14, 15) for the engagement of a respective pinion (16, 17, 43, 44).

### BACKGROUND

The invention relates to a rack for a rack-and-pinion steering system of a motor vehicle and also to a rack-and-pinion steering system with this rack.

From DE69607549T2, for example, a rack with variable pitch of the teeth is known. The effective teeth width of each rack tooth of the area with variable pitch gradually increases or decreases in width, from a center position of the row of rack teeth in the direction toward an end area of the row of rack teeth. Because the effective tooth width becomes narrower, the contact position of the rack tooth with the threaded pinion is adjusted in the direction toward the center of the tooth width.

Racks with variable pitch are used, for example, in rack-and-pinion steering systems of motor vehicles in which the steering feel is to be improved. With the help of the variable rack, a steering transmission ratio between the steering angle and the average wheel angle of a pair of steered wheels can be progressive. Consequently, for example, for a steering wheel rotation of 180 degrees starting from a straight ahead position of the steered wheels, the adjustment travel covered by the rack along its rack axis can be less than for a steering wheel rotation of 180 degrees for a significantly turned-out position of the steered wheels. In the straight ahead position of the steering wheel, a greater steering system transmission ratio can be set in order to not let the steering become unsteady. To drive the wheels, the steering system transmission ratio can be reduced, to allow less steering wheel rotations for turning and parking maneuvers.

Typically, tie rods are connected via tie rod joints to the axial ends of the rack of a rack-and-pinion steering system, wherein these tie rods attach at their ends facing away from the rack to steering arms that drive the steered wheels. The construction of the system limits a steering angle of the steered wheels by the adjustment travel of the rack along its rack axis.

### SUMMARY

The objective of the present invention is to provide a rack that allows greater steering movements of the steered wheels. This objective is met by the rack having one or more features of the invention. Therefore, because the rack is formed by two rack parts that are arranged moveable relative to each other and are both provided with an identical toothed section for the engagement of each pinion, there are numerous possibilities for increasing the adjustment travel of the rack along its rack axis. The distance between the start and end of the rack that is formed according to the invention from two rack parts can be variable in one variant, so that, for the connected tie rods and steering arms, new structural options are possible. This rack can thus undergo a targeted compression and elongation under displacements along the rack axis. The division of the rack into two rack parts can be provided in another variant such that both rack parts are arranged with a spatial distance from each other, which opens up new structural possibilities for the construction of the vehicle.

Preferably a pitch of the teeth along the toothed section is constructed as a known variable pitch. Such a variable pitch is disclosed, for example, in the publication cited above. Racks with variable pitch can mesh, for example, with a pinion formed as a helical pinion. The pitch can become initially larger, for example, beginning at a start of the toothed section to an end of the toothed section, then become smaller, and finally become larger again.

The pitch between two teeth of the toothed section arranged directly adjacent to each other can be, in a variable toothed section in the sense of the invention, dependent on the position of these teeth between a start and an end of the toothed section. A center position of the toothed section designates a place between the start and the end of the toothed section in which a neutral position of the rack is set, thus, the steering vehicle wheels are adjusted for straight ahead driving of the vehicle. In this center position, a pitch between teeth arranged adjacent to each other can be smaller than farther away from this center position. In this way, a steady straight ahead travel is possible; small steering pivoting movements of the steering wheel, that is, small rotational movements of a pinion provided for engagement in the rack, result in only minor movements of the rack parts along the rack axis. With increasing distance from this center position, the pitch can become greater, for example, to make maneuvering the vehicle easier. The change in the pitch starting from the center position can be designed as a function of the desired driving comfort settings.

The two toothed sections of the two rack parts each have identical designs over the provided adjustment area of the rack according to the invention. This means that the two toothed sections can have unequal lengths, for example, for reasons due to production; it is essential that the sections of the two toothed sections meshing with the pinions are identical.

The variable pitch of the two rack parts along the toothed section can be constructed, for example, such that the pitch increases non-linearly from a start to an end of the toothed section. This progressive toothed section can be used to accommodate the need of the driver for an improved steering feel.

If, for example, the two rack parts are arranged coaxial and longitudinally displaceable relative to each other, a variable pitch of the teeth along the toothed section allows a greater steering angle of the steered wheels to be set.

If the two identical toothed sections formed with variable pitch in the two rack parts are arranged mirror-inverted to each other and the pinions that are formed, for example, as helical pinions, and mesh in the toothed sections are rotated in the same direction, then one rack part can be displaced farther along the rack axis due to an increasing pitch, while the other rack part, in contrast, undergoes a shorter adjustment travel along the rack axis due to the decreasing pitch. In this way, during steering movements, a compression or elongation of the rack according to the invention is realized.

The two rack parts can be guided longitudinally displaceable relative to each other at their ends facing each other. For example, one rack part can be guided longitudinally displaceable in a recess of the other rack part, so that the mentioned compression or elongation of the rack according to the invention is possible with sufficient stiffness for the rack.

In a rack-and-pinion steering system provided with a rack according to the invention in a motor vehicle, a pinion engages in both toothed sections of the rack part. In a neutral position of the rack—that is, for straight ahead driving of the vehicle—the pinions are arranged in a center position between a start and an end of the toothed section. This center position is such that a toothed section length between the center position and an end of the toothed section facing the tie rod connecting point is greater than a toothed section length between the center position and a start of the toothed section facing away from the tie rod connecting point. This means that the rack for pivoting the wheel on the inside of the curve must cover a greater total path than for pivoting the outer wheel. Accordingly, the averaged pitch to one side of the pinion is greater than to the other side.

A refinement according to the invention provides a rack-and-pinion steering system that will be described in more detail below. This rack-and-pinion steering system according to the invention can each provide a drive mechanism for each rack part, wherein these drive mechanisms support the pivotings of the rack parts along their rack axis. In a known way, this drive mechanism can have a ball screw whose threaded spindle is connected to the rack part for transmitting adjusting movements of the threaded spindle to the rack part, wherein an electric motor is provided that drives a spindle nut of the ball screw. The adjusting movements exerted by the driver via the steering wheel on the engaging pinions are supported by the mentioned drive mechanisms.

For an axially short rack-and-pinion steering system it is provided that the threaded spindle of the ball screw is arranged at a parallel distance to and next to the rack part. While in known rack-and-pinion steering systems with power steering the threaded spindle forms a separate section of the rack—and consequently means an axial extension of the rack—this refinement according to the invention allows an axially significantly shorter construction and simultaneously greater adjusting paths of the rack according to the invention along its rack axis.

In this rack-and-pinion steering system according to the invention, the two rack parts can each be supported on their ends facing away from each other on a tie rod.

It is known that such tie rods are supported on steering arms of wheel bearings, wherein these steering arms drive the steered wheels. In this refinement according to the invention, an angle beta between the active axes of the steering arm and the tie rod in the neutral position of the two rack parts—for straight ahead driving of a motor vehicle—is less than 90 degrees. The active axes connect the joining points of the tie rod and the steering arm in a straight line. This configuration will be described in more detail below.

During slow driving, the curving travel of a vehicle is exact only when the normals to the centers of all four wheels meet at a point. The rear wheels do not turn, so the normals to the two front wheels must intersect the extension of the rear axle center line in a common point. This means that, on the front wheel on the inside of the curve and on the front wheel on the outside of the curve, different steering angles are created. Starting from the larger, inner angle, a desired value can be calculated for the outer angle that is also designated as the so-called Ackermann angle. When the two steering angles of the two steered wheels are defined in this way, the so-called Ackermann condition is fulfilled.

In many cases, for a trouble-free fulfillment of this Ackermann condition it is provided that the axes of the steering arm are arranged at an angle to each other and intersect approximately in the center of the rear axle. In this position of the steering arm, from geometrical reasons it results that for completely turned-out wheels, an angle beta between the active axes of the tie rod and the steering arm can be very large on the side of the wheel on the inside of the curve, so that nearly a stretched position of the tie rod and the steering arm is reached. This stretched position can be prevented in that the steering arm—and thus also the steering arm axis—is arranged in a different position in order to reduce the angle between the tie rod and steering arm on the wheel on the inside of the curve for completely turned-out wheels. However, this changed arrangement of the steering arm is associated with the disadvantage that the extended axes of the steering arm no longer meet approximately at the center of the rear axle, so that it is very difficult to fulfill the Ackermann condition mentioned above.

The rack according to the invention, however, allows a fulfillment of the Ackermann condition due to the compression or elongation described farther above even for an angle that is reduced according to the invention between the steering arm and the tie rod.

The two pinions engaging in the rack parts can be connected for common rotational movements in the same direction, for example, by means of toothed belts or chains or a common gearwheel. Under a rotational movement of the pinions, one pinion is rotated in the direction toward the start of the toothed section and the other pinion is rotated in the direction toward the end of the toothed section relative to each track part. Due to the variable pitch—that is, for example, progressive or non-linear toothed section—the two steered wheels are pivoted so that finally the Ackermann condition is fulfilled again.

The two rack parts of the rack according to the invention can also be arranged at an angle to each other, wherein, in particular, in the front area of a vehicle, space can be created in this way that is available for other vehicle elements.

The rack-and-pinion steering system described here comprises, with regard to terms, only the components named in the claims. Other components, for example, a rack housing or bearing for tie rods or steering arms, could be added, but are not essential parts of the rack-and-pinion system claimed here.

### BRIEF DESCRIPTION OF THE DRAWINGS

The invention will be explained in more detail below with reference to two embodiments shown in the overall total of seven figures. Shown are:

FIG. 1 a rack-and-pinion steering system according to the invention with a rack according to the invention in a first view,

FIG. 2 the rack-and-pinion steering system and the rack from FIG. 1, sectioned,

FIG. 3 the rack-and-pinion steering system according to the invention from FIG. 1 in another view,

FIG. 4 the rack-and-pinion steering system according to the invention from FIG. 1 installed in a vehicle, in a schematic view,

FIG. 5 an alternative rack according to the invention and an alternative rack-and-pinion steering system according to the invention with this rack,

FIG. 6 a known rack-and-pinion steering system in schematic view,

FIG. 7 the rack-and-pinion steering system from FIG. 6 with turned-out wheels.

### DETAILED DESCRIPTION OF THE PREFERRED EMBODIMENTS

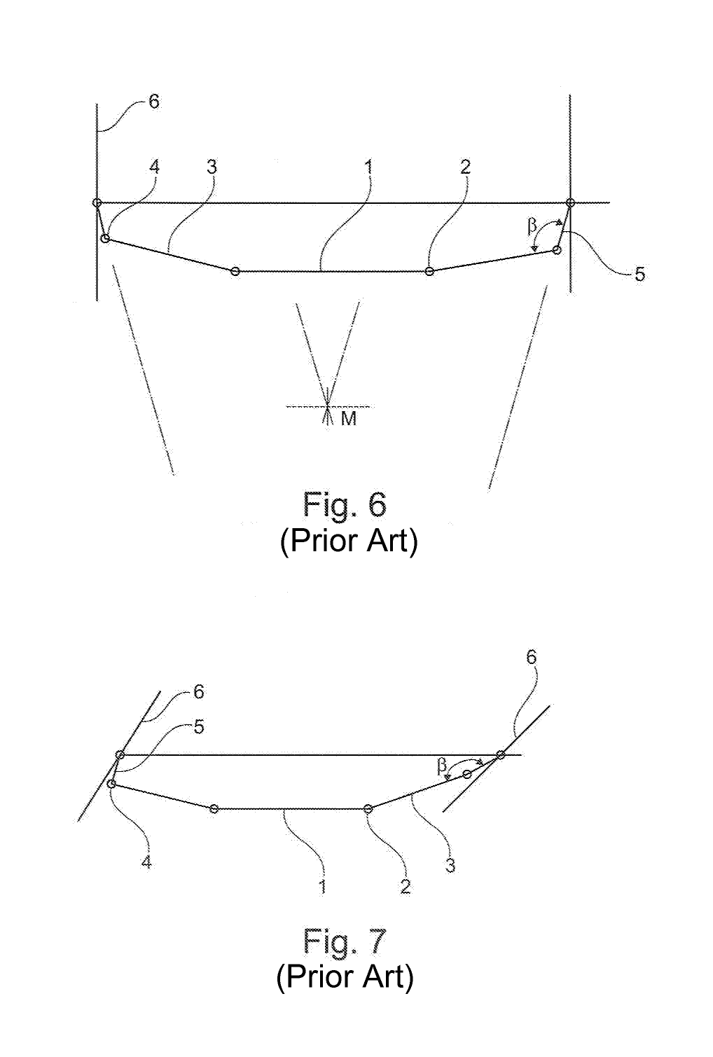

For better understanding of the invention, first the basic problem will be explained with reference to a known rack-and-pinion steering system, as shown schematically in FIGS. 6 and 7: a rack 1 is connected to tie rods 3 at its axial ends by means of tie rod joints 2, wherein these tie rods are connected to steering arms 5 at their ends facing away from each other by means of steering arm joints 4, wherein these steering arms engage wheel bearings that are not shown in more detail to drive the steered wheels 6. From FIG. 6 it can be seen that the active axes of the steering arm 5 intersect in an intersecting point M that lies on the rotational axis of the non-steered rear wheels of a vehicle. In the figure, this intersecting point M is shown offset. This design of the steering arm 5 can be an essential prerequisite for fulfilling the so-called Ackermann condition as described in the introduction.

In the neutral position of the rack-and-pinion steering system (FIG. 6)—that is, for straight ahead driving of the vehicle—an angle beta between the tie rod and the active axis of the steering arm 5 is provided that is significantly greater than 90 degrees.

FIG. 7 shows the situation for turned-out wheels. The wheel shown on the right in the figure is, in this case, the wheel on the inside of the curve, whose steering angle is greater than the steering angle of the wheel on the outside of the curve. From this figure it can be seen that, due to the large steering angle in the wheel on the inside of the curve, the angle beta is significantly increased, so that nearly a stretched position of the steering arm 5 and tie rod 3 is set. This means that a larger steering angle is not possible for structural reasons.

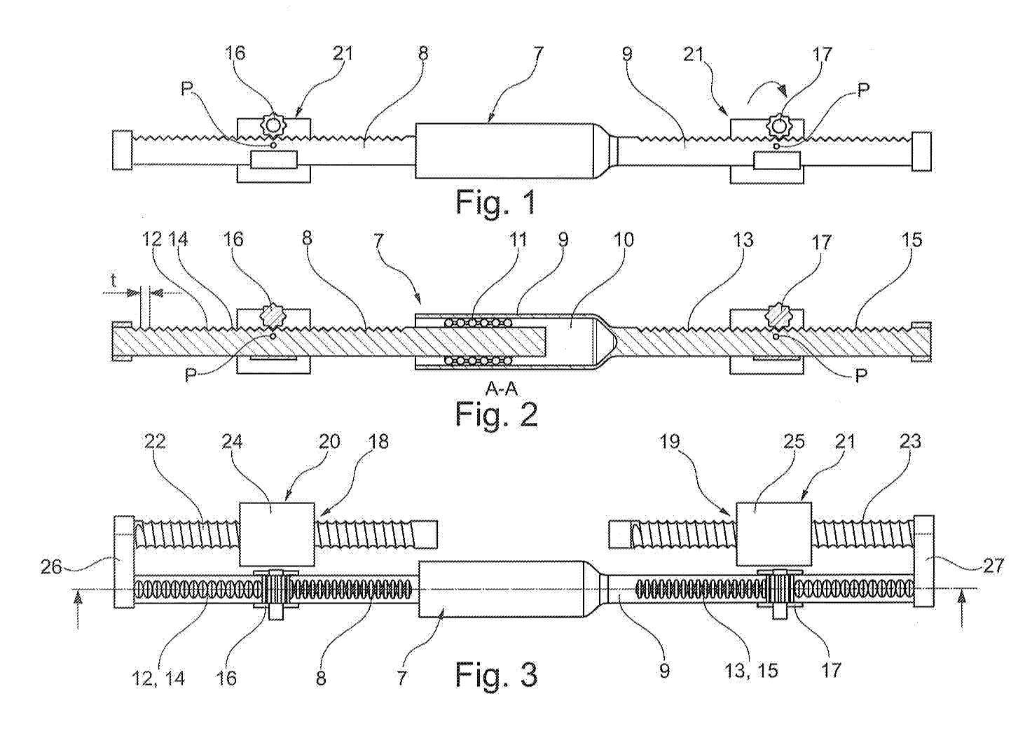

FIGS. 1, 2, and 3 show a first variant of a rack-and-pinion steering system according to the invention with a rack according to the invention. Here, in contrast, significantly larger steering angles of the steered wheels are possible.

This rack 7 according to the invention has two rack parts 8, 9 that are arranged coaxially and nested one in the other. The rack part 9 has a recess 10 in which the rack part 8 meshes, wherein, in this engagement, a longitudinal guide 11 is provided that allows an axial displacement of the two rack parts 8, 9 along a common rack axis. In the embodiment, the longitudinal guide 11 is formed by a linear bearing that comprises rolling bodies that roll on raceways of the two rack parts 8, 9.

Both rack parts 8, 9 have an identical toothed section 12, 13, wherein a pitch t of the teeth 14, 15 arranged one behind the other along the rack axis increases from a start of the toothed section 12, 13 to an end of the toothed section 12, 13. In the embodiment, the pitch t increases from right to left for the rack part 8. In the rack part 9, the pitch t increases from left to right. The two toothed sections 12, 13 are consequently arranged essentially mirror-inverted to each other.

The rack-and-pinion steering system comprises pinions 16, 17 that mesh with the toothed section 12 and the toothed section 13 of the two rack parts 8, 9. Both pinions 16, 17 are actuated together by means of a not-shown steering mechanism and always rotate in the same direction. FIGS. 1 to 3 show a neutral position of the rack-and-pinion steering system, that is, straight ahead driving of the not-shown vehicle. In this neutral position, the pinions 16, 17 engage at a center position P in the toothed section 12, 13. The pitch t to both sides of the center position P is different from each other: towards the ends facing away from each other in the rack parts 8, 9, the pitch t becomes bigger, toward the ends of the rack parts 8, 9 facing each other, the pitch t becomes smaller.

In particular, from FIG. 3 it can be seen that two drive mechanisms 18, 19 are provided that each support a longitudinal displacement of one of the rack parts 8, 9 along its rack axis. Both drive mechanisms 18, 19 have a ball screw 20, 21 that each has a threaded spindle 22, 23 and also a spindle nut 24, 25 arranged so that it can rotate on the threaded spindle 22, 23. The two spindle nuts 24, 25 are each driven by a not-shown motor; alternatively, both spindle nuts 24, 25 can be driven by a common motor.

Both threaded spindles 22, 23 are connected on their ends facing away from each other by means of a bearing plate 26, 27 to the respectively allocated rack part 8, 9.

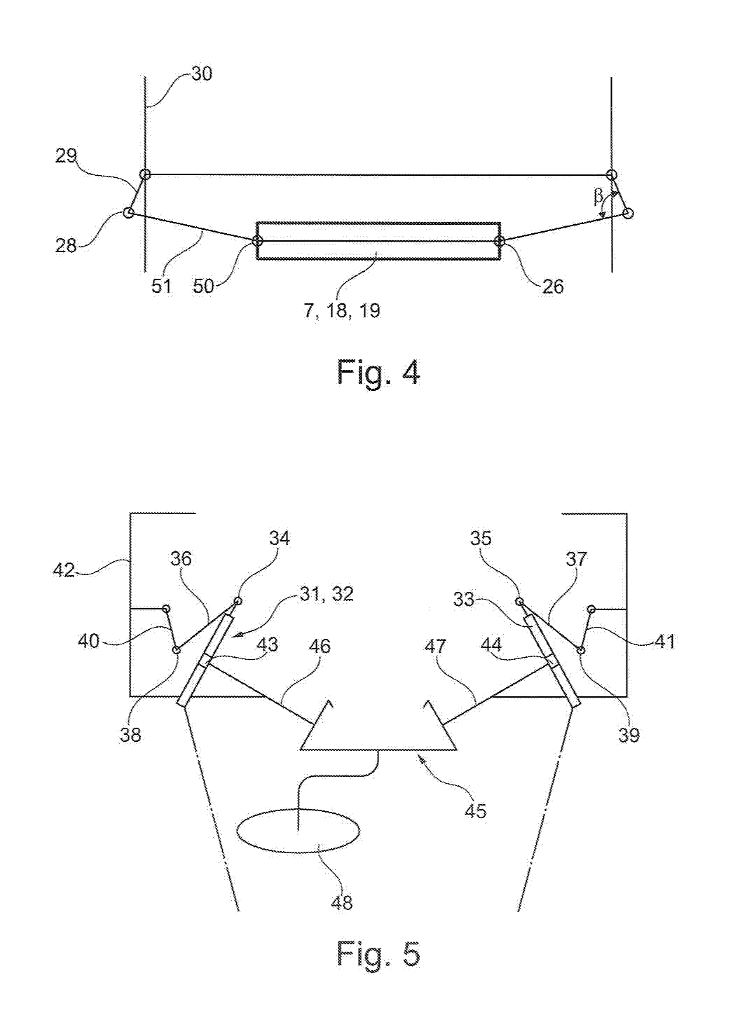

Under a common actuation of the pinions 16, 17, for example, in the clockwise direction (FIG. 1), both rack parts 8, 9 are shifted to the left. However, the rack part 9 is shifted over a longer adjustment travel due to the increasing pitch t and the rack part 8 due to its decreasing pitch t. This means that the rack part 9 is shifted farther starting from the shown neutral position than the rack part 8. The rack 7 is consequently shorter. This unequal pivoting of the two rack parts 8, 9 allows greater steering angles of the steered wheels in rack-and-pinion steering systems, as explained below with reference to FIG. 4.

The rack 7 according to the invention shown in FIGS. 1 to 3 and also the drive mechanisms 18, 19 are shown symbolically by a rectangle in FIG. 4 only schematically. The rack 7 is connected on its ends facing away from each other by means of tie rod joints 50 to tie rods 51 that are in turn connected with their ends facing away from each other by means of steering arm joints 28 to steering arms 29, wherein these steering arms 29 drive not-shown wheel bearings in order to steer the steered wheels 30.

From FIG. 4 it can be clearly seen that different from the known arrangement according to FIG. 6, the steering arms 29 are arranged such that an angle beta between the tie rod 51 and the active axis of the steering arm 29 is less than 90 degrees. This means, in the arrangement of the steering arm 29 described here, the wheels 30 can undergo a greater steering angle up to a nearly stretched position between the steering arm and the tie rod.

The rack 7 according to the invention allows, for an axially short construction, a correspondingly large pivoting of the steered wheels 30.

The combination of the rack 7 according to the invention with the arrangement of the tie rods 51 and the steering arm 29 according to FIG. 4 allows adherence to the so-called Ackermann condition, according to which the normals from the centers of all four wheels meet at a point—the curve center. In the embodiment, the rear wheels (not shown) are not steered, so that the normals to the two front wheels intersect the extension of the rear axle center line, wherein different steering angles are produced on the front wheel on the inside of the curve and on the front wheel on the outside of the curve, with these steering angles corresponding to the so-called Ackermann condition.

FIG. 5 shows a variant according to the invention in a rack 31 according to the invention, whose rack parts 32, 33 are arranged at an angle to each other, wherein installation space is created between these two rack parts 32, 33 for additional vehicle components.

The two rack parts 32, 33 are connected at one end by means of tie rod joints 34, 35 to tie rods 36, 37, wherein their ends facing away from the tie rod joints 34, 35 are connected by means of steering arm joints 38, 39 to steering arms 40, 41 that drive the steered wheels 42 by means of not-shown wheel bearings.

Both rack parts 32, 33 are provided with a non-linear toothed section as was also described in the preceding embodiment. In this embodiment, the two rack parts 32, 33 are arranged mirror-inverted to each other, wherein the pitch of the not-shown toothed section of these rack parts 32, 33 increases from the lower end shown in FIG. 5 in each rack part 32, 33 in the direction toward the upper end.

From FIG. 5 it can be further seen that pinions 43, 44 mesh with the two rack parts 32, 33, wherein both pinions 43, 44 are driven by means of a common ball screw 45. Output shafts 46, 47 of the ball screw 45 are locked in rotation to the two pinions 43, 44, wherein the two output shafts 46, 47 are arranged at an angle to each other. Under actuation of the ball screw 45, both output shafts rotate in the same direction if their direction of rotation is detected starting from the ball screw with a viewing direction toward the pinions 43, 44. On the input side, the ball screw 45 is connected here to an only indicated steering wheel 48 of the vehicle.

Under actuation of the steering wheel 48, the pinions 43, 44 rotate, for example, in the clockwise direction, as was already described above, so that the rack part 32 in FIG. 5 is displaced downward and the rack part 33 in FIG. 5 is displaced upward along each rack axis. The two wheels 42 are consequently steered to the right, wherein the wheel 42 shown on the right in FIG. 5 is the wheel on the inside of the curve, whose pivoting is greater than the pivoting of the wheel 42 shown on the left in FIG. 5, the wheel on the outside of the curve. These differing pivot angles of the two wheels 42 are caused by the non-linear toothed sections of the two rack parts 32, 33, as was already explained in the embodiment described above. In this embodiment according to the invention, very large steering angles can also be implemented.

### LIST OF REFERENCE NUMBERS

1 Rack

2 Tie rod joint

3 Tie rod

4 Steering arm joint

5 Steering arm

6 Wheel

7 Rack

8 Rack part

9 Rack part

10 Recess

11 Longitudinal guide

12 Toothed section

13 Toothed section

14 Tooth

15 Tooth

16 Pinion

17 Pinion

18 Drive mechanism

19 Drive mechanism

20 Ball screw

21 Ball screw

22 Threaded spindle

23 Threaded spindle

24 Spindle nut

25 Spindle nut

26 Bearing plate

27 Bearing plate

28 Steering arm joint

29 Steering arm

30 Wheel

31 Rack

32 Rack part

33 Rack part

34 Tie rod joint

35 Tie rod joint

36 Tie rod

37 Tie rod

38 Steering arm joint

39 Steering arm joint

40 Steering arm

41 Steering arm

42 Wheel

43 Pinion

44 Pinion

45 Ball screw

46 Output shaft

47 Output shaft

48 Steering wheel

50 Tie rod joint

51 Tie rod

1. A rack for a rack-and-pinion steering system of a motor vehicle, comprising two rack parts each having an identical variable toothed section formed from a plurality of teeth arranged along a rack axis for engagement of a respective pinion, the two rack parts are arranged to move relative to each other.

2. The rack according to claim 1, wherein a pitch of the teeth along the toothed section is variable.

3. The rack according to claim 2, wherein the pitch (t) between two of the teeth arranged directly adjacent to each other is dependent on the position of said teeth between a start and an end of the toothed section.

4. The rack according to claim 2, wherein the identical toothed sections of the two rack parts are arranged mirror-inverted with respect to each other.

5. The rack according to claim 1, wherein both of the rack parts are guided longitudinally displaceable with respect to each other at ends thereof facing each other.

6. The rack according to claim 5, wherein one of the rack parts is guided longitudinally displaceable in a recess of the other of the rack parts.

7. The rack according to claim 1, wherein the two rack parts are arranged at an angle to each other.

8. A rack-and-pinion steering system of a motor vehicle with the rack according to claim 1, wherein both of the pinions engage in a neutral position of the rack-and-pinion steering system in a center position (P) of the toothed section of the associated rack part set between a start and an end of the toothed section.

9. The rack-and-pinion steering system of a motor vehicle with a rack according to claim 1, wherein for both of the rack parts a drive mechanism is provided that supports a pivoting of the rack parts along a rack axis.

10. The rack-and-pinion steering system according to claim 9, wherein the drive mechanism comprises a ball screw with threaded spindle that is connected to the rack part for transmitting setting movements of the threaded spindle to the rack part, and an electric motor is provided that drive a spindle nut of the ball screw.

11. The rack-and-pinion steering system according to claim 10, wherein the threaded spindle is arranged at a parallel distance to and next to the rack part.

12. The rack-and-pinion steering system according to claim 8, wherein each of the rack parts is supported on ends thereof facing away from each other on a tie rod.

13. The rack-and-pinion steering system according to claim 12, wherein the tie rods are supported on steering arms of wheel bearings, wherein an angle β between active axes of the steering arm and the tie rods in the neutral position of the rack is less than 90 degrees.

14. The rack-and-pinion steering system according to claim 8, wherein one of the pinions meshes with the toothed sections of the two rack parts, and both of the pinions are connected to each other for common rotational movements in a same direction.

15. The rack-and-pinion steering system according to claim 8, wherein under a rotational movement of the pinion, one of the pinions is displaced in a direction toward the beginning of the toothed section and the other pinion is displaced in a direction toward the end of the toothed section relative to the respective rack part.
